(19) United States
(12) Patent Application Publication
(10) Pub. No.: US 2010/0046126 A1
(43) Pub. Date: Feb. 25, 2010

(54) CIRCUIT INTERRUPTER AND RECEPTACLE INCLUDING SEMICONDUCTOR SWITCHING DEVICE PROVIDING PROTECTION FROM A GLOWING CONTACT

(76) Inventor: Robert T. Elms, Monroeville, PA (US)

Correspondence Address: Martin J. Moran;Eaton Electrical, Inc., 1000 Cherrington Parkway, Moon Township, PA, 15108, US

(21) Appl. No.: 12/194,962

(22) Filed: Aug. 20, 2008

(51) Int. Cl. H02H 9/08; H02H 5/04

(52) U.S. Cl. 361/42; 361/103

(57) ABSTRACT

A receptacle includes a housing, an input connection, an output connection, separable contacts structured to electrically connect the input connection and the output connection, an operating mechanism structured to open the separable contacts responsive to a trip signal, and a trip circuit. The trip circuit is structured to generate the trip signal responsive to current flowing to or from the output connection. The trip circuit includes a trip detection circuit and a semiconductor switching device. The semiconductor switching device is mounted within the housing and is located within about 0.25 inch of the input connection or the output connection. The semiconductor switching device is structured to generate the trip signal responsive to the trip detection circuit and responsive to overheating of the input connection or the output connection, respectively.

### BACKGROUND OF THE INVENTION

1. Field of the Invention

This invention pertains generally to electrical switching apparatus and, more particularly, to circuit interrupters. The invention also pertains to receptacles.

2. Background Information

Circuit interrupters include, for example, circuit breakers, receptacles, contactors, motor starters, motor controllers and other load controllers.

Ground fault circuit interrupters (GFCIs) include ground fault circuit breakers (GFCBs), ground fault switches, ground fault receptacles, and other ground fault contactors, motor starters, motor controllers and other load controllers.

Arc fault circuit interrupters (AFCIs) include arc fault circuit breakers (AFCBs), arc fault switches, arc fault receptacles, and other arc fault contactors, motor starters, motor controllers and other load controllers.

Ground fault and/or arc fault switches include ground fault and/or arc fault receptacles (GFRs/AFRs), and cord-mounted or plug-mounted ground fault and/or arc fault protection devices (e.g., ground fault and/or arc fault protection circuitry at the alternating current (AC) plug end of an AC power cord of an appliance, such as a hair dryer).

A glowing contact is a high resistance connection, which can form, for example, at the interface of a conductor (e.g., wire) and a screw terminal (e.g., line terminal; neutral terminal), for example, of a receptacle. A glowing contact is also possible, for example, at a receptacle outlet where a male three-prong plug mates with three-sets of outlet contact blades of the receptacle outlet. A glowing contact at a receptacle is known to produce substantial heat that can melt the receptacle and start a fire. It is very easy to create a high resistance or glowing contact at a receptacle terminal using copper wire. The hazards associated with glowing contacts, including contacts made with all combinations of copper, brass and iron are known. See, for example, U.S. Pat. Nos. 6,948,846; and 6,707,652.

According to UL 1699 (Arc-Fault Circuit-Interrupters) (scope 1.3), AFCIs providing arc fault detection are not intended to detect glowing connections and, thus, it is believed that AFCIs do not provide glowing contact protection.

It is known to employ a temperature sensor (e.g., a thermal relay; a bimetal) to sense a temperature at about 200° C. and provide glowing contact protection for a receptacle.

U.S. Pat. No. 6,707,652 discloses a receptacle including a first temperature sensor that outputs a first signal representative of a first temperature of a line circuit, a second temperature sensor that outputs a second signal representative of a second temperature of a neutral circuit, and a circuit that provides a glowing contact trip signal as a function of a difference between the first temperature and the second temperature.

There is room for improvement in circuit interrupters.

There is also room for improvement in receptacles.

### SUMMARY OF THE INVENTION

These needs and others are met by embodiments of the invention, which provide a number of semiconductor switching devices mounted within a housing and located within about 0.25 inch of an input connection or an output connection of a circuit interrupter. The number of semiconductor switching devices are structured to generate a trip signal responsive to a trip detection circuit and responsive to overheating of the input connection or the output connection.

In accordance with one aspect of the invention, a receptacle comprises: a housing; an input connection; an output connection; separable contacts structured to electrically connect the input connection and the output connection; an operating mechanism structured to open the separable contacts responsive to a trip signal; and a trip circuit structured to generate the trip signal responsive to current flowing to or from the output connection, the trip circuit comprising a trip detection circuit and a semiconductor switching device, the semiconductor switching device being mounted within the housing and being located within about 0.25 inch of the input connection or the output connection, the semiconductor switching device being structured to generate the trip signal responsive to the trip detection circuit and responsive to overheating of the input connection or the output connection, respectively.

The output connection may comprise an outlet structured to supply power to a load; and the semiconductor switching device may be mounted within about 0.25 inch of the outlet.

The outlet may comprise a plurality of pairs of contact blades; and the semiconductor switching device may be mounted within about 0.25 inch of at least one of the pairs of contact blades.

The output connection may comprise two outlets structured to supply power to two loads; and the semiconductor switching device may be mounted within about 0.25 inch of both of the two outlets.

The housing may comprise a face; the output connection may comprise two outlets structured to supply power to two loads; the two outlets may be mounted on the face; and the semiconductor switching device may be mounted proximate the face and within about 0.25 inch of both of the two outlets.

The trip circuit may comprise a test button and a reset button mounted on the face and between the two outlets; and the semiconductor switching device may be mounted behind the face and proximate the test button and the reset button.

The semiconductor switching device may be a first triac; the trip circuit may further comprise a second triac electrically connected parallel to the first triac; the output connection may comprise two outlets structured to supply power to two loads; the first triac may be mounted within about 0.25 inch of the first outlet; and the second triac may be mounted within about 0.25 inch of the second outlet.

The semiconductor switching device may be a first silicon-controlled rectifier; the trip circuit may further comprise a second silicon-controlled rectifier electrically connected parallel to the first silicon-controlled rectifier; the output connection may comprise two outlets structured to supply power to two loads; the first silicon-controlled rectifier may be mounted within about 0.25 inch of the first outlet; and the second silicon-controlled rectifier may be mounted within about 0.25 inch of the second outlet.

As another aspect of the invention, a circuit interrupter comprises: an input connection; an output connection; separable contacts structured to electrically connect the input connection and the output connection; an operating mechanism structured to open the separable contacts responsive to a trip signal; and a trip circuit structured to generate the trip signal responsive to current flowing to or from the output connection, the trip circuit comprising a trip detection circuit and a semiconductor switching device, the semiconductor switching device being located within about 0.25 inch of the input connection or the output connection, the semiconductor switching device being structured to generate the trip signal responsive to the trip detection circuit and responsive to overheating of the input connection or the output connection, respectively.

### BRIEF DESCRIPTION OF THE DRAWINGS

A full understanding of the invention can be gained from the following description of the preferred embodiments when read in conjunction with the accompanying drawings in which:

FIG. 1 is an isometric view of a receptacle in accordance with embodiments of the invention.

FIG. 2 is an isometric view of a receptacle including two triacs in an AFCI trip circuit in accordance with another embodiment of the invention.

FIG. 3 is an isometric view of a receptacle including a number of SCRs in accordance with another embodiment of the invention.

FIG. 4 is an isometric view of a GFCI receptacle including a GFCI trip circuit in accordance with another embodiment of the invention.

FIG. 5 is an isometric view of a receptacle including screw terminals in accordance with another embodiment of the invention.

FIG. 6 is a block diagram of a circuit interrupter in accordance with another embodiment of the invention.

FIG. 7 is a block diagram of two parallel semiconductor switching devices in accordance with embodiments of the invention.

### DESCRIPTION OF THE PREFERRED EMBODIMENTS

As employed herein, the term “number” shall mean one or an integer greater than one (i.e., a plurality).

As employed herein, the term “semiconductor switching device” means a triac or a silicon-controlled rectifier (SCR) (or thyristor).

As employed herein, the term “input connection” means an input terminal, a line terminal, a receptacle screw terminal, an input contact stab, or a line contact stab.

As employed herein, the term “output connection” means an output terminal, a load terminal, a receptacle outlet, or a load contact stab.

The invention is described in association with receptacles and circuit interrupters, although the invention is applicable to any suitable AFCI receptacle, GFCI receptacle or AFCI/GFCI receptacle, as well as a wide range of circuit interrupters (e.g., without limitation, circuit breakers).

Certain arc fault circuit breakers will trip if the circuit temperature exceeds about 110° C. to about 120° C. In the AFCI trip circuit of those arc fault circuit breakers, the semiconductor switching device (e.g., a triac) is self turned-on at a temperature above about 110° C. In turn, this applies power to a trip solenoid, which trips the arc fault circuit breaker. However, the input and output connections of those arc fault circuit breakers are not believed to be proximate to the semiconductor switching device.

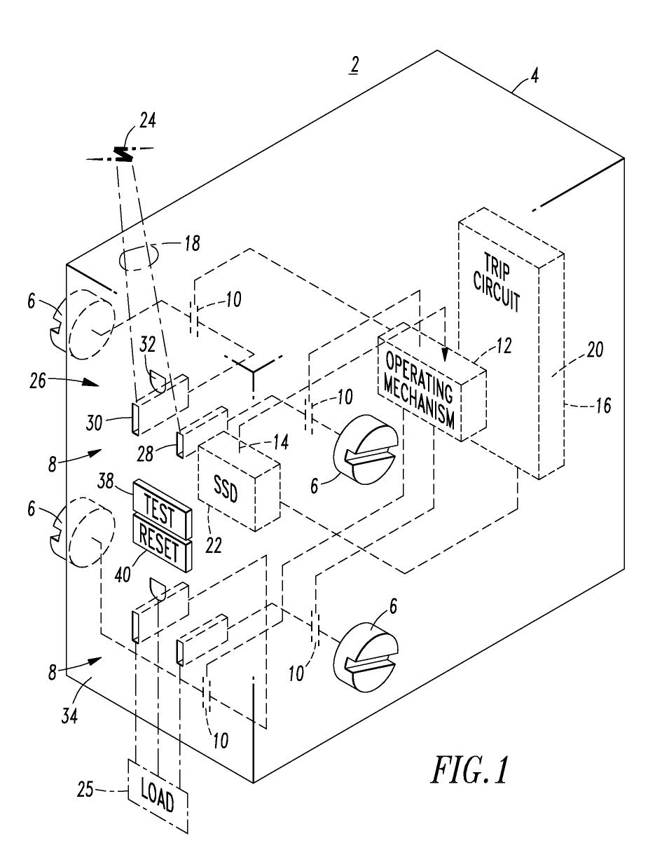

Referring to FIG. 1, a receptacle 2 is shown. The receptacle 2 includes a housing 4, an input connection 6, an output connection 8, and separable contacts 10 (shown in hidden line drawing) structured to electrically connect the input connection 6 and the output connection 8. An operating mechanism 12 (shown in hidden line drawing) is structured to open the separable contacts 10 responsive to a trip signal 14 (shown in hidden line drawing) (e.g., through a solenoid (not shown) responsive to the trip signal 14). A trip circuit 16 (shown in hidden line drawing) is structured to generate the trip signal 14 responsive to current 18 (shown in phantom line drawing) flowing to or from the output connection 8. The trip circuit 16 includes a trip detection circuit 20 (shown in hidden line drawing) and a semiconductor switching device (SSD) 22 (shown in hidden line drawing). The semiconductor switching device 22 is mounted within the housing 4 and is located within about 0.25 inch of the input connection 6 or the output connection 8. The semiconductor switching device 22 is structured to generate the trip signal 14 responsive to the trip detection circuit 20 and responsive to overheating of the input connection 6 or the output connection 8, respectively.

In this example, the trip detection circuit 20 is an arc fault trip detector structured to activate the semiconductor switching device 22 responsive to an arc fault condition 24 (shown in phantom line drawing) (e.g., without limitation, a series or parallel arc in a load conductor (not shown)) or load neutral conductor (not shown) operatively associated with the output connection 8. Although an arc fault trip detector 20 is shown, the invention is applicable to ground fault trip detectors or arc fault/ground fault trip detectors.

As shown in the example of FIG. 1, the output connection 8 is a number of outlets 8 structured to supply power to a number of loads (one load 25 is shown in phantom line drawing). The example semiconductor switching device 22 is mounted within about 0.25 inch of the output connection 8. Although not required, the semiconductor switching device 22 can be encapsulated by an insulator (not shown).

### EXAMPLE 1

As is conventional, the output connection 8 can include a plurality of pairs of contact blades 26 (e.g., three pairs are shown for line 28, neutral 30 and ground 32).

The semiconductor switching device 22 is mounted within about 0.25 inch of at least one of the pairs of the contact blades 26.

### EXAMPLE 2

The semiconductor switching device 22 can be a triac.

### EXAMPLE 3

The trip detection circuit 20 can be an arc fault trip detector structured to activate the semiconductor switching device 22 responsive to the arc fault condition 24 operatively associated with the output connection 8.

### EXAMPLE 4

Further to Example 3, the AFCI receptacle 2 includes the same or similar AFCI trip circuit 16 as an AFCI circuit breaker (not shown), except that the semiconductor switching device 22 is mounted within about 0.25 inch of at least one receptacle outlet 8 (e.g., receptacle contact blades 26; receptacle outlet connection contact sets, which are different from the internal contacts (not shown) of a receptacle's internal trip relay (not shown)) or between the two receptacle outlets 8 where heat is generated in response to a glowing contact at one or both of the outlets 8. Hence, this mechanical configuration is useful to provide glowing contact protection as will be described.

### EXAMPLE 5

Further to Example 4, as shown in FIG. 1, the semiconductor switching device 22 (e.g., a triac) is mounted proximate the face 34 of the receptacle 2 and within about 0.25 inch of both of the two receptacle outlets 8. As a result, a glowing contact at either outlet connection contact set will heat the receptacle face 34 between the two outlet connection contact sets. If the triac temperature reaches about 110° C., then the receptacle 2 trips since the triac 22 is self turned-on.

It is believed that use of a number of semiconductor switching devices 22 (e.g., a number of triacs) as temperature sensing and tripping devices, without additional circuitry, but with suitable mechanical positioning of such semiconductor switching devices within about 0.25 inch of the receptacle outlets 8 (e.g., first outlet contact set; second outlet contact set) is novel and advantageously provides glowing contact protection.

### EXAMPLE 6

Further to Example 5, the triac 22 is preferably mounted internal to and in thermal contact with the receptacle housing 4. For example, in response to a glowing contact, a housing (e.g., made of plastic) of a receptacle can melt within about 0.25 inch of the receptacle outlet(s).

### EXAMPLE 7

Further to Example 6, a “TEST” button 38 and a “RESET” button 40 on the receptacle 2 are located between the two outlet connection contact sets near where the triac 22 is located. A user resetting a tripped receptacle will immediately feel a temperature above about 60° C. and recognize that a problem exists.

### EXAMPLE 8

Preferably, the AFCI receptacle 2 includes two outlets 8 and the semiconductor switching device 22 is mounted proximate the receptacle face 34 and within about 0.25 inch of both of the two outlets 8.

### EXAMPLE 9

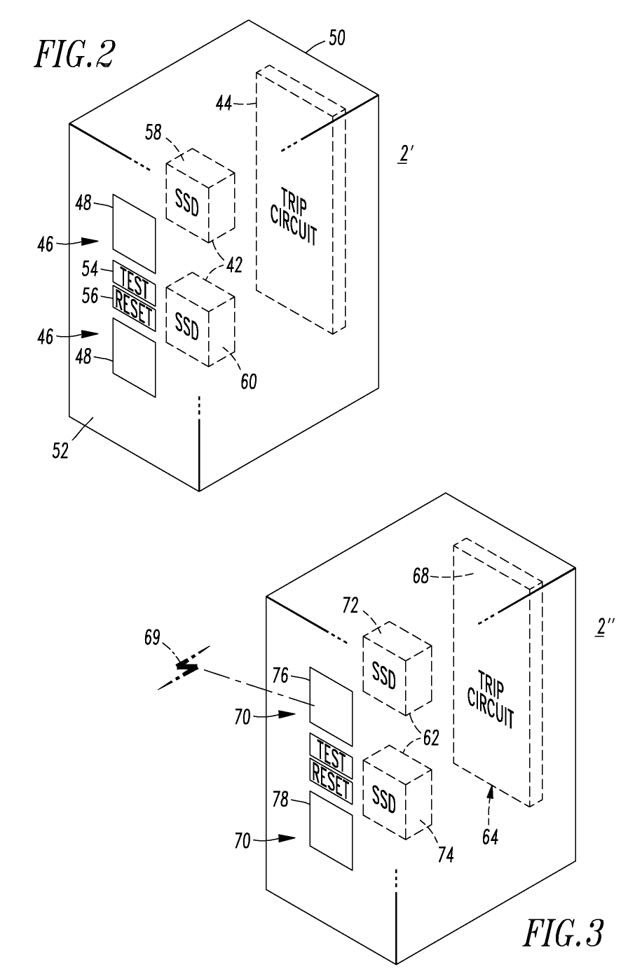

FIG. 2 shows another receptacle 2′ including two semiconductor switching devices 42 (e.g., triacs; SCRs) (shown in hidden line drawing) in a trip circuit 44 (shown in hidden line drawing).

Except for the two semiconductor switching devices 42, the receptacle 2′ may be similar to the receptacle 2 of FIG. 1.

In this example, the output connection 46 includes two outlets 48 structured to supply power to two loads (not shown). Each of the semiconductor switching devices 42 is mounted within about 0.25 inch of a corresponding one of the two outlets 48. In this example, the semiconductor switching devices 42 are electrically connected in parallel (i.e., gate-to-gate, anode-to-anode, and cathode-to-cathode) (see, for example, FIG. 7, which shows parallel devices 72,74). Either of the two semiconductor switching devices 42 is self turned-on (e.g., by heat from the corresponding one of the two outlets 48) at a temperature above about 110° C.

### EXAMPLE 10

The receptacle 2′ further includes a housing 50 having a face 52. The two outlets 48 are mounted on the receptacle face 52. The semiconductor switching devices 42 are mounted proximate the face 52 and within about 0.25 inch of both of the two outlets 48.

### EXAMPLE 11

Further to Example 10, a “TEST” button 54 and a “RESET” button 56 are mounted on the receptacle face 52 and between the two outlets 48. The two semiconductor switching devices 42 are mounted behind the face 52 and proximate the buttons 54,56.

### EXAMPLE 12

The semiconductor switching devices 42 are two triacs 58,60, which are electrically connected in parallel as was discussed above in connection with Example 9. The first triac 58 is mounted within about 0.25 inch of the first outlet 48, and the second triac 60 is mounted within about 0.25 inch of the second outlet 48. This provides a relatively more rapid sensing of excessive temperature(s) and, in response, a relatively more rapid trip.

### EXAMPLE 13

FIG. 3 shows another receptacle 2″ including a number of semiconductor switching devices 62 (e.g., a number of silicon-controlled rectifiers (SCRs)) (shown in hidden line drawing) in a trip circuit 64 (shown in hidden line drawing).

Except for the number of silicon-controlled rectifiers (SCRs)), the receptacle 2″ may be similar to the receptacle 2 of FIG. 1, or the receptacle 2′ of FIG. 2.

### EXAMPLE 14

Further to Example 13, the trip circuit 64 includes an arc fault trip detection circuit 68 (shown in hidden line drawing) structured to activate the number of semiconductor switching devices 62 (shown in hidden line drawing) responsive to an arc fault condition 69 (shown in phantom line drawing) operatively associated with output connection 70.

### EXAMPLE 15

The number of semiconductor switching devices 62 can be a first SCR 72 (shown in hidden line drawing) and a second SCR 74 (shown in hidden line drawing). In this example, the SCRs 72,74 are electrically connected in parallel (i.e., gate-to-gate, anode-to-anode, and cathode-to-cathode), as shown in FIG. 7. The output connection 70 includes two outlets 76,78 structured to supply power to two loads (not shown). The first SCR 72 is mounted within about 0.25 inch of the first outlet 76, and the second SCR 74 is mounted within about 0.25 inch of the second outlet 78. Either of the two SCRs 72,74 is self turned-on (e.g., by heat from the corresponding one of the two outlets 76,78) at a temperature above about 110° C.

### EXAMPLE 16

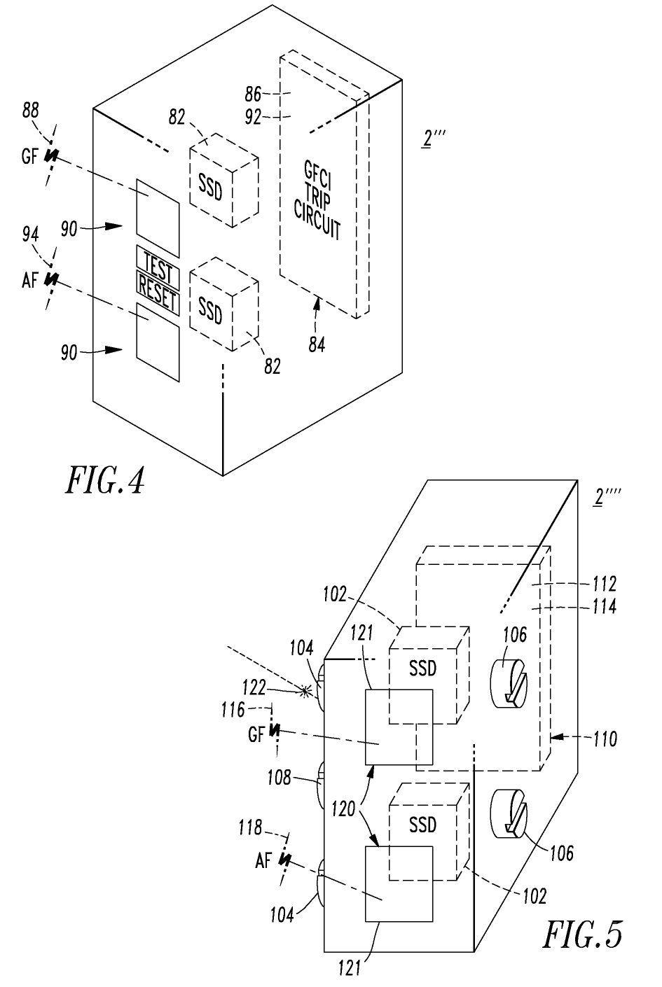

FIG. 4 shows another receptacle 2′″ including a number of semiconductor switching devices 82 (e.g., a number of triacs; a number of SCRs)) (shown in hidden line drawing) in a GFCI trip circuit 84 (shown in hidden line drawing). Except for the GFCI trip circuit 84, the receptacle 2′″ may be similar to the receptacle 2 of FIG. 1, the receptacle 2′ of FIG. 2, or the receptacle 2″ of FIG. 3. The trip circuit 84 includes a ground fault trip detector 86 (shown in hidden line drawing) structured to activate the number of semiconductor switching devices 82 responsive to a ground fault (GF) condition 88 (shown in phantom line drawing) operatively associated with the output connection 90.

### EXAMPLE 17

The trip circuit 84 can also include an arc fault trip detector 92 (shown in hidden line drawing) structured to activate the number of semiconductor switching devices 82 (shown in hidden line drawing) responsive to an arc fault (AF) condition 94 (shown in phantom line drawing) operatively associated with the output connection 90.

### EXAMPLE 18

It will be appreciated that the receptacle 2′″ of FIG. 4 can use the two parallel triacs 42 of FIG. 2, and/or a number of other semiconductor switching devices (e.g., a number of SCRs), and/or a combination AFCI/GFCI trip circuit, and/or two parallel SCRs similar to the two parallel SCRs 72,74 of FIGS. 3 and 7.

### EXAMPLE 19

FIG. 5 shows another receptacle 2″″ including a number of semiconductor switching devices 102 (shown in hidden line drawing), a line screw terminal 104, a neutral screw terminal 106, and a ground screw terminal 108. Except for the screw terminals 104,106,108, the receptacle 2″″ may be similar to the receptacle 2 of FIG. 1, the receptacle 2′ of FIG. 2, the receptacle 2″ of FIG. 3, or the receptacle 2′″ of FIG. 4.

A trip circuit 110 (shown in hidden line drawing) includes a trip detection circuit 112 (shown in hidden line drawing) having a ground fault and arc fault trip detector 114 (shown in hidden line drawing) structured to activate the number of semiconductor switching devices 102 (shown in hidden line drawing) responsive to a ground fault (GF) condition 116 (shown in phantom line drawing) or an arc fault (AF) condition 118 (shown in phantom line drawing) operatively associated with an output connection 120, which can include two example outlets 121.

### EXAMPLE 20

As shown in FIG. 5, a glowing contact 122 (shown in phantom line drawing) can form in connection with the line or neutral screw terminals 104,106 of the receptacle 2″″. In many receptacles, the receptacle outlets and the screw terminals are in relatively close proximity (e.g., within about 0.5 inch). In such receptacles, the number of semiconductor switching devices 102 (e.g., a number of triacs; a number of SCRs) is located between the two receptacle outlets 121 and between the four screw terminals 104,106 (i.e., line and neutral screw terminals 104,106 for both outlets 121). Preferably, a number of the triacs or SCRs are mechanically positioned within about 0.25 inch of each of the six electrical connections (i.e., the two receptacle outlets 121 and the four screw terminals 104,106).

### EXAMPLE 21

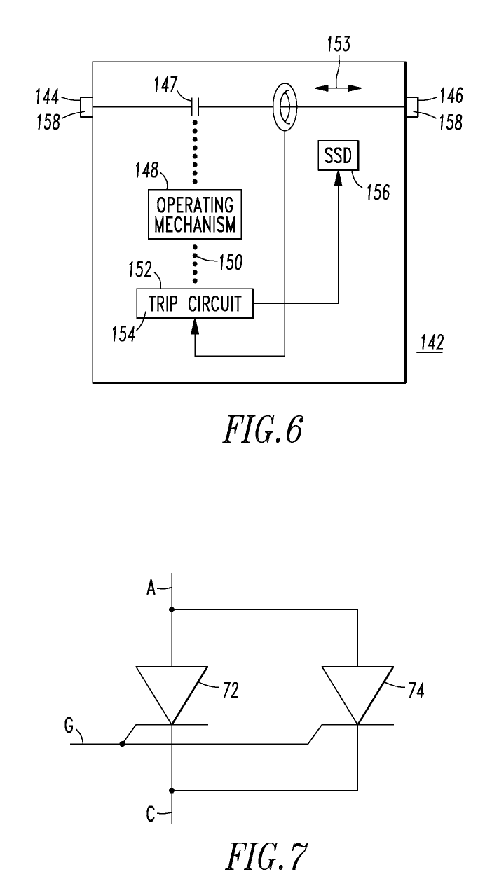

FIG. 6 shows a circuit interrupter 142 including an input connection 144, an output connection 146, separable contacts 147 structured to electrically connect the input connection 144 and the output connection 146, an operating mechanism 148 structured to open the separable contacts 147 responsive to a trip signal 150, and a trip circuit 152 structured to generate the trip signal 150 responsive to current 153 flowing to or from the output connection 146. The trip circuit 152 includes a trip detection circuit 154 and a semiconductor switching device (SSD) 156. The semiconductor switching device 156 is located within about 0.25 inch of the input connection 144 or the output connection 146 (as shown), and is structured to generate the trip signal 150 responsive to the trip detection circuit 154 (as is conventional) and responsive to overheating of the input connection 144 or the output connection 146, respectively.

Although FIG. 6 shows one semiconductor switching device 156 proximate the output connection 146, the semiconductor switching device 156 may be proximate the input connection 144, or another parallel semiconductor switching device (not shown) may be proximate the input connection 144 as was discussed above in connection with FIG. 2.

### EXAMPLE 22

For example, the input connection 144 can include one or both of a line terminal and a neutral terminal. The output connection 146 can include one or both of a load terminal and a load neutral terminal.

### EXAMPLE 23

The circuit interrupter 142 can be a circuit breaker. At least one of the input connection 144 and the output connection 146 can be a contact stab 158.

### EXAMPLE 24

Further to Example 23, the input connection 144 and the output connection 146 are a line contact stab and a load contact stab, respectively. For example, the trip circuit semiconductor switching device 156 provides over temperature protection from a bad line/load stab connection.

The disclosed receptacles 2,2′,2″,2′″,2″″ and circuit interrupter 142 employ the “protective” turn-on characteristic of a semiconductor switching device, such as a trip circuit triac or SCR, at relatively high temperatures, in order to provide additional glowing contact protection for such receptacles and circuit interrupter.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A receptacle comprising:
a housing;
an input connection;
an output connection;
separable contacts structured to electrically connect said input connection and said output connection;
an operating mechanism structured to open said separable contacts responsive to a trip signal; and
a trip circuit structured to generate said trip signal responsive to current flowing to or from said output connection, said trip circuit comprising a trip detection circuit and a semiconductor switching device, said semiconductor switching device being mounted within said housing and being located within about 0.25 inch of said input connection or said output connection, said semiconductor switching device being structured to generate said trip signal responsive to said trip detection circuit and responsive to overheating of said input connection or said output connection, respectively.

2. The receptacle of claim 1 wherein said trip detection circuit is an arc fault trip detector structured to activate said semiconductor switching device responsive to an arc fault condition operatively associated with said output connection.

3. The receptacle of claim 1 wherein said trip detection circuit is a ground fault trip detector structured to activate said semiconductor switching device responsive to a ground fault condition operatively associated with said output connection.

4. The receptacle of claim 1 wherein said trip detection circuit is a ground fault and arc fault trip detector structured to activate said semiconductor switching device responsive to a ground fault condition or an arc fault condition operatively associated with said output connection.

5. The receptacle of claim 1 wherein said output connection comprises an outlet structured to supply power to a load; and wherein said semiconductor switching device is mounted within about 0.25 inch of said outlet.

6. The receptacle of claim 5 wherein said outlet comprises a plurality of pairs of contact blades; and wherein said semiconductor switching device is mounted within about 0.25 inch of at least one of said pairs of contact blades.

7. The receptacle of claim 1 wherein said output connection comprises two outlets structured to supply power to two loads; and wherein said semiconductor switching device is mounted within about 0.25 inch of both of said two outlets.

8. The receptacle of claim 1 wherein said housing comprises a face; wherein said output connection comprises two outlets structured to supply power to two loads; wherein said two outlets are mounted on said face; and wherein said semiconductor switching device is mounted proximate said face and within about 0.25 inch of both of said two outlets.

9. The receptacle of claim 8 wherein said trip circuit comprises a test button and a reset button mounted on said face and between said two outlets; and wherein said semiconductor switching device is mounted behind said face and proximate said test button and said reset button.

10. The receptacle of claim 1 wherein said semiconductor switching device is a triac.

11. The receptacle of claim 10 wherein said trip detection circuit is an arc fault trip detector structured to activate said semiconductor switching device responsive to an arc fault condition operatively associated with said output connection.

12. The receptacle of claim 10 wherein said trip detection circuit is a ground fault trip detector structured to activate said semiconductor switching device responsive to a ground fault condition operatively associated with said output connection.

13. The receptacle of claim 10 wherein said trip detection circuit is a ground fault and arc fault trip detector structured to activate said semiconductor switching device responsive to a ground fault condition or an arc fault condition operatively associated with said output connection.

14. The receptacle of claim 1 wherein said semiconductor switching device is a first triac; wherein said trip circuit further comprises a second triac electrically connected parallel to said first triac; wherein said output connection comprises two outlets structured to supply power to two loads; wherein said first triac is mounted within about 0.25 inch of said first outlet; and wherein said second triac is mounted within about 0.25 inch of said second outlet.

15. The receptacle of claim 1 wherein said semiconductor switching device is a silicon-controlled rectifier.

16. The receptacle of claim 15 wherein said trip detection circuit is an arc fault trip detector structured to activate said semiconductor switching device responsive to an arc fault condition operatively associated with said output connection.

17. The receptacle of claim 15 wherein said trip detection circuit is a ground fault trip detector structured to activate said semiconductor switching device responsive to a ground fault condition operatively associated with said output connection.

18. The receptacle of claim 15 wherein said trip detection circuit is a ground fault and arc fault trip detector structured to activate said semiconductor switching device responsive to a ground fault condition or an arc fault condition operatively associated with said output connection.

19. The receptacle of claim 1 wherein said semiconductor switching device is a first silicon-controlled rectifier; wherein said trip circuit further comprises a second silicon-controlled rectifier electrically connected parallel to said first silicon-controlled rectifier; wherein said output connection comprises two outlets structured to supply power to two loads; wherein said first silicon-controlled rectifier is mounted within about 0.25 inch of said first outlet; and wherein said second silicon-controlled rectifier is mounted within about 0.25 inch of said second outlet.

20. A circuit interrupter comprising:
an input connection;
an output connection;
separable contacts structured to electrically connect said input connection and said output connection;
an operating mechanism structured to open said separable contacts responsive to a trip signal; and
a trip circuit structured to generate said trip signal responsive to current flowing to or from said output connection, said trip circuit comprising a trip detection circuit and a semiconductor switching device, said semiconductor switching device being located within about 0.25 inch of said input connection or said output connection, said semiconductor switching device being structured to generate said trip signal responsive to said trip detection circuit and responsive to overheating of said input connection or said output connection, respectively.

21. The circuit interrupter of claim 20 wherein said circuit interrupter is a circuit breaker; and wherein at least one of said input connection and said output connection is a contact stab.

22. The circuit interrupter of claim 20 wherein said circuit interrupter is a circuit breaker; and wherein said input connection and said output connection are a line contact stab and a load contact stab, respectively.
